(19) United States
(12) Patent Application Publication
(10) Pub. No.: US 2021/0288362 A1
(43) Pub. Date: Sep. 16, 2021

(54) THERMAL MANAGEMENT MULTILAYER SHEET FOR A BATTERY

(71) Applicant: ROGERS CORPORATION, CHANDLER, AZ (US)

(72) Inventor: CHRISTOPHER CHURCHILL, DAYVILLE, CT (US)

(21) Appl. No.: 17/196,595

(22) Filed: Mar. 9, 2021

Related U.S. Application Data
(60) Provisional application No. 62/988,662, filed on Mar. 12, 2020.

(51) Int. Cl. H01M 10/6551; H01M 10/613; H01M 10/647; H01M 50/244; H01M 10/0525

(52) U.S. Cl. CPC H01M 10/6551; H01M 10/613; H01M 10/0525; H01M 50/244; H01M 10/647

(57) ABSTRACT

Thermal management multilayer sheet, including a first heat-spreading layer, a first side of a first integrity layer disposed on a side of the first heat spreading layer, a first side of a first adhesive layer disposed on an opposite second side of the first integrity layer, a second integrity layer, and a second heat-spreading layer, wherein a first side of the second integrity layer is disposed on an opposite second side of the adhesive layer, and the second heat-spreading layer is disposed on an opposite second side of the second integrity layer; or a first side of the second heat-spreading layer is disposed on an opposite second side of the first adhesive layer, a first side of the second integrity layer is disposed on an opposite second side of the second heat-spreading layer, and a second adhesive layer is disposed on an opposite second side of the second integrity layer.

### CROSS-REFERENCE TO RELATED APPLICATIONS

This application claims priority to and the benefit of U.S. Provisional Application No. 62/988,662 filed on Mar. 12, 2020, the entire content of which is incorporated herein by reference.

### BACKGROUND

This disclosure is directed to a thermal management multilayer sheet for use in batteries, in particular for use in delaying or preventing thermal runaway in lithium-ion batteries. The disclosure is further directed to methods for the manufacture of the thermal management multilayer sheet, assemblies for batteries, and batteries including the thermal management multilayer sheet.

The demand for electrochemical energy storage devices, such as lithium-ion batteries, is ever increasing due to the growth of applications such as electric vehicles and grid energy storage systems, as well as other multi-cell battery applications, such as electric bikes, uninterrupted power battery systems, and lead acid replacement batteries. For large format applications, such as grid storage and electric vehicles, multiple electrochemical cells connected in series and parallel arrays are often used. Once a cell is in thermal runaway mode, the heat produced by the cell can induce a thermal runaway propagation reaction in adjacent cells with the potential to cause a cascading effect that can ignite the entire battery.

While attempts to reduce the flammability of such batteries have been considered, many can have drawbacks. For example, modifying the electrolyte by adding flame retardant additives, or using inherently non-flammable electrolytes have been considered, but these approaches can negatively impact the electrochemical performance of the lithium-ion cell. Other approaches to prevent cascading thermal runaway include incorporating an increased amount of insulation between cells or groups of cells to reduce the amount of thermal heat transfer during a thermal event. However, these approaches can limit the upper bounds of the energy density that can be achieved.

With the increasing demand for batteries with reduced risk of thermal runaway, there is accordingly a need for materials for use in batteries that prevent or delay the spread of heat, energy, or both to surrounding cells.

### BRIEF SUMMARY

Disclosed herein is a thermal management multilayer sheet, including a first heat-spreading layer, a first side of a first integrity layer disposed on a side of the first heat spreading layer, a first side of a first adhesive layer disposed on an opposite second side of the first integrity layer, a second integrity layer, and a second heat-spreading layer, wherein a first side of the second integrity layer is disposed on an opposite second side of the adhesive layer, and the second heat-spreading layer is disposed on an opposite second side of the second integrity layer, wherein the first adhesive layer is a single layer or multi-layer adhesive; or a first side of the second heat-spreading layer is disposed on an opposite second side of the first adhesive layer, a first side of the second integrity layer is disposed on an opposite second side of the second heat-spreading layer, and a second adhesive layer is disposed on an opposite second side of the second integrity layer.

Also disclosed herein is an assembly for a battery including at least two electrochemical cells; and a thermal management multilayer sheet, wherein the thermal management multilayer sheet includes a first heat-spreading layer, a first side of a first integrity layer disposed on a side of the first heat spreading layer, and an adhesive layer disposed on an opposite second side of the first integrity layer.

Batteries including the above-described assembly are also disclosed.

The above described and other features are exemplified by the following figures, detailed description, examples, and claims.

### BRIEF DESCRIPTION OF THE DRAWINGS

The following figures are exemplary aspects, which are provided to illustrate the present disclosure. The Figures that are illustrative of the examples are not intended to limit devices made in accordance with the disclosure to the materials, conditions, or process parameters set forth herein.

FIG. 1 is a schematic illustration of a pouch cell with a thermal management multilayer sheet adhered to an exterior of the pouch cell;

FIG. 2 is an illustration of an aspect of a thermal management multilayer sheet;

FIG. 3 is an illustration of an aspect of a thermal management multilayer sheet;

FIG. 4 is an illustration of an aspect of a thermal management multilayer sheet located in between two electrochemical cells;

FIG. 5 is an illustration of an aspect of a thermal management multilayer sheet located between two electrochemical cells;

FIG. 6 is an illustration of an aspect of a thermal management multilayer sheet located in a cell array;

FIG. 7 is an illustration of an aspect of a pouch cell battery; and

FIG. 8 is an illustration of an aspect of an assembly for a battery including the thermal management multilayer sheet.

### DETAILED DESCRIPTION

Preventing thermal runaway in batteries that include a plurality of cells is a difficult problem, as cells adjacent to a cell experiencing a thermal runaway can absorb enough energy from the event to cause them to rise above their designed operating temperatures, triggering the adjacent cells to also enter into thermal runaway. This propagation of initiating a thermal runaway event can result in a chain reaction in which storage devices enter into a cascading series of thermal runaways, as the cells transfer heat to adjacent cells.

The thermal barrier provided by the thermal management multilayer sheet can also be used at various sites in batteries to prevent thermal runaway. Thus, use of the thermal management multilayer sheet can reduce thermal conductivity in any one or more directions. The thermal management multilayer sheet can further improve the fire resistance of batteries.

Accordingly, described herein are assemblies for a battery and batteries that include an electrochemical cell or electrochemical cell array comprising a thermal management multilayer sheet, wherein the thermal management multilayer sheet is disposed directly on a surface (i.e., contacts at least a portion of at least one surface) of an electrochemical cell. As used herein, an electrochemical cell (or “cell”) is the basic unit of a battery including an anode, a cathode, and an electrolyte. A “cell array” means an assembly of two or more electrochemical cells, e.g., two, five, twenty, fifty, or more. The cell or cell array in association with the thermal management multilayer sheet and optionally another battery component, such as a separator, a current collector, a housing such as a flexible pouch, or the like are referred to herein as an “assembly for a battery.” An assembly for a battery and a battery can include a single electrochemical cell, a single cell array, or a plurality of cell arrays.

A variety of electrochemical cell types can be used, including pouch cells, prismatic cells, or cylindrical cells. A single cell or a cell array can be in a flexible enclosure such in a pouch cell. In an aspect, the cells are lithium-ion cells, for example lithium iron phosphate, lithium cobalt oxide, or other lithium metal oxide cells. Other types of cells that can be used include nickel metal hydride, nickel cadmium, nickel zinc, or silver zinc.

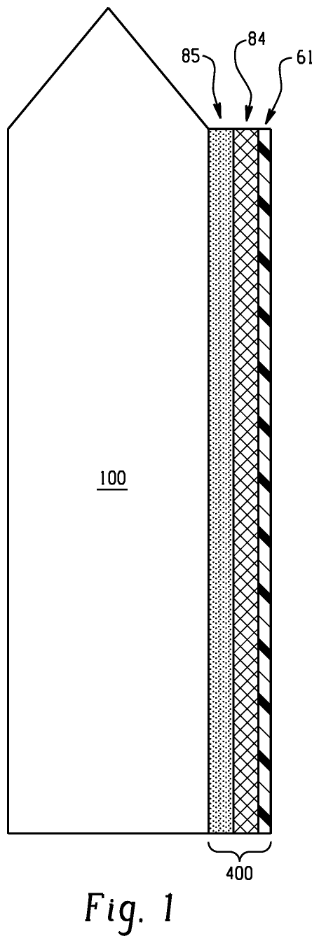

As illustrated in FIG. 1, the thermal management multilayer sheet 400 can be placed directly on or adhered to the exterior surface of a pre-formed cell, for example, on the exterior surface of a pouch cell 100. Pouch cell 100 can have a first adhesive layer 85 adhered to an exterior surface thereof and a first integrity layer 84 can be disposed on a side of the first adhesive layer 85 opposite the pouch cell 100. A first heat-spreading layer 61 is disposed on a side of the first integrity layer 84 opposite the first integrity layer 84. The first adhesive layer 85, first integrity layer 84, and first heat-spreading layer 61 can be a DW 407 plasma tape.

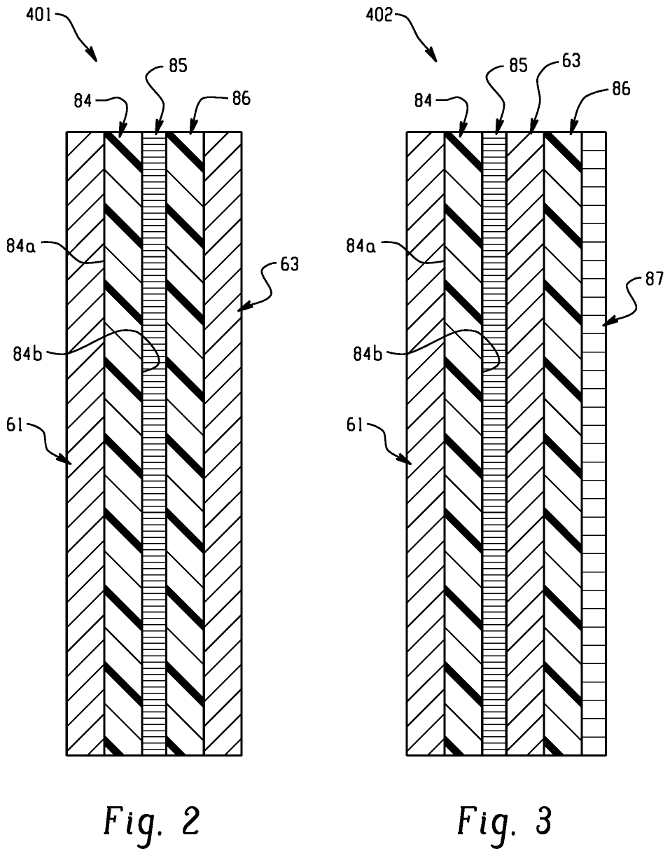

FIG. 2 illustrates an aspect of a thermal management multilayer sheet 401 comprising a first heat-spreading layer 61 disposed on a first side 84a of a first integrity layer 84. A second side 84b of the first integrity layer 84 comprises a first adhesive layer 85. The first adhesive layer 85 may be a single layer or a multilayer adhesive. A second integrity layer 86 is disposed on a side of the first adhesive layer 85 opposite the first integrity layer 84. The first adhesive layer 85 adheres the first and second integrity layers 84, 86. A second heat-spreading layer 63 is disposed on a side of the second integrity layer 86 opposite the first adhesive layer 85.

FIG. 3 illustrates an aspect of a thermal management multilayer sheet 402 comprising a first heat-spreading layer 61 disposed on a first side 84a of a first integrity layer 84. A second side 84b of the first integrity layer 84 comprises a first adhesive layer 85. A second heat-spreading layer 63 is disposed on a side of the first adhesive layer 85 opposite the first integrity layer 84. A second integrity layer 86 is disposed on a side of second heat-spreading layer 63 opposite the first adhesive layer 85. A second adhesive layer 87 is disposed on a side of second integrity layer 86 opposite the second heat-spreading layer 63.

The thermal management multilayer sheet may include heat-spreading layers, integrity layers, and adhesive layers in addition to those shown in FIGS. 1-3. Generally, up to ten heat-spreading layers, and ten integrity layers with adhesive layers can be employed to provide the desired thermal management multilayer sheet.

As stated above, the cells of the cell array can be prismatic cells, pouch cells, cylindrical cells, and the like, and are preferably pouch cells. In an aspect, the cells are lithium-ion cells. In another aspect, the cells are lithium-ion pouch cells.

The first and second heat-spreading layers 61, 63 each independently comprise a material with high thermal conductivity (Tc), such as greater than 10 Watts per meter-Kelvin (W/m*K), preferably greater than 50 W/m*K, or more preferably greater than 100 W/m*K, each as measured at measured at 23° C. For example, the material can have a thermal conductivity of 10 to 6,000 W/m*K) at 23° C., or 50 to 6,000 W/m*K) at 23° C., or 100 to 6,000 W/m*K), or 100 to 1,000 W/m*K, or 100 to 500 W/m*K, each as measured at 23° C. Such materials include metals such as copper, aluminum, silver, or an alloy of copper, aluminum, or silver; a ceramic such as boron nitride, aluminum nitride, silicon carbide, or beryllium oxide; or a carbonaceous material such as carbon fibers, carbon nanotubes, graphene, or graphite. In an aspect, the first and second heat-spreading layer independently can include copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof. For example, the heat-spreading layer can be a tape or sheet comprising carbon fibers or carbon nanotubes, such as the those available from Huntsman under the trade name MIRALON. In other aspects the heat-spreading layer is a metal or metal alloy foil, preferably aluminum or an aluminum alloy. In an aspect, the first and second heat-spreading layers are each independently a foil, a woven or nonwoven fiber mat, or a polymer foam. The first and second heat-spreading layers 61, 63 can be the same or different.

The thickness of the first and second heat-spreading layers depends on the material used, the degree of thermal conductivity desired, cost, desired thickness, or weight of the battery, or like considerations. For example, the heat-spreading layers can have a thickness of 5 to 1,000 micrometers (μm), such as 0.0005 to 0.039 inches (12.7 to 991 μm), 0.001 to 0.005 inches (25.4 to 127 μm), or 0.002 to 0.039 inches (51 to 991 micrometers). The metal foils can each independently have a thickness of 0.0005 to 0.020 inches (12.7 to 508 μm), or 0.001 to 0.005 inches (25.4 to 127 μm).

The adhesive layer(s) can have a thickness of 0.00025 to 0.010 inches (6 to 254 μm), or 0.0005 to 0.003 inches (12.7 to 76 μm). A wide variety of adhesives are known in the art and can be used. For example, the adhesive layers can each independently comprise a polyester adhesive, a polyvinyl fluoride adhesive, an acrylic or methacrylic adhesive, or a silicone adhesive. In an aspect, the adhesive is a silicone adhesive. Solvent-cast, hot-melt, and two-part adhesives can be used. In an aspect, each adhesive layer can independently comprise an inorganic filler that can be heat-spreading or thermally-insulating.

Optionally, each of the adhesive layers can independently include a filler that can be heat-spreading (thermally conducting) or thermally insulating. Exemplary fillers include aerogel fillers, glass microballoons, gas-filled hollow polymer microspheres, boron nitride, aluminum nitride, mica, talc, carbon nanotubes, graphite, or a combination thereof. The additives can be surface coated to provide desired characteristics, for example the fillers can be treated with a silane to improve dispersion or adhesion. For example, each adhesive layer can include a high aspect ratio platy filler such as mica or talc. In an aspect, no filler is present.

An aerogel is an open-celled solid matrix comprising a network of interconnected nanostructures with a porosity of greater than 50 volume percent (vol %), more preferably greater than 90 vol %. Aerogels can be derived from a gel by replacing the liquid component in the gel with a gas, or by drying a wet gel, such as by supercritical drying. Exemplary aerogels include polymer aerogels, including poly(vinyl alcohol), urethane, polyimide, or polyacrylamide aerogels; polysaccharide aerogels including chitin and chitosan aerogels; or inorganic ceramic aerogels such as aluminum oxide or silica aerogels.

The first and second integrity layers 84, 86 are a reinforcement material to reinforce the strength of the thermal management multilayer. Each can independently include continuous fibers, for example, in the form of a woven or nonwoven fibrous mat that can have a thickness of 20 to 600 μm, or of 0.001 to 0.020 inches (25.4 to 508 μm), preferably 0.001 to 0.005 inches (25.4 to 127 μm). The first and second integrity layers can comprise a high heat resistance woven or nonwoven polymer mat, e.g., a polyetherimide, a polysulfone, a polyphthalamide, a polyphenylene sulfide, a polyarylate, a polyether ether ketone, or the like; or a woven nonwoven glass mat, such as a fiberglass.

Polymer fibers can include one or more of a wide variety of thermoplastics, blends of thermoplastics, or thermosetting resins. Examples of thermoplastics that can be used include polyacetals, polyacrylics, polyamides such as Nylon 6, Nylon 6,6, Nylon 6,10, Nylon 6,12, Nylon 11 or Nylon 12, polyamideimides, polyarylates, polycarbonates, polystyrenes, polyesters such as polyethylene terephthalate (PET), polybutylene terephthalate (PBT) and polyethylene naphthalate (PEN), polyetherketones, polyether etherketones, polyether ketone ketones, polyetherimides, polyolefins such as polypropylene, polyethylene, or copolymers of polyethylene or polypropylene, polyphenylene sulfides, polystyrene, polysulfones such as polyarylsulfones and polyethersulfones, polyurethanes, polyvinyl chlorides, fluorinated polymers such as polychlorotrifluoroethylenes, polyvinylidene fluorides (PVDF), polyvinyl fluorides, polytetrafluoroethylenes, perfluoromethyl vinylethers, fluorinated polyethylene-propylene (FEP), or tetrafluoroethylene-vinylidene fluoride-hexafluoropropylene (HFP), ethylene propylene rubbers (EPR), ethylene propylene diene monomer rubbers (EPDM), styrene-acrylonitrile (SAN), styrene-maleic anhydride (SMA), acrylonitrile-butadiene-styrene (ABS), a natural rubber, a nitrile rubber, butyl rubber, a cyclic olefin copolymer, polydicyclopentadiene rubber, styrene-ethylene/propylene-styrene block copolymer (SEPS), a styrene-butadiene block copolymer (SB), a styrene-butadiene-styrene) copolymer (SBS), a styrene-ethylene/butylene-styrene block copolymer (SEBS), a polybutadiene, an isoprene, a polybutadiene-isoprene copolymer, or the like, or a combination thereof.

Examples of blends of thermoplastic polymers that can be used in the polymer fibers include ABS/nylon, polycarbonate/ABS, ABS/polyvinyl chloride, polyphenylene ether/polystyrene, polyphenylene ether/nylon, polysulfone/ABS, polycarbonate/thermoplastic urethane, polycarbonate/PET, polycarbonate/PBT, thermoplastic elastomer alloys, PET/PBT, SMA/ABS, polyether etherketone/polyethersulfone, styrene-butadiene rubber, polyethylene/nylon, polyethylene/polyacetal, or the like, or a combination thereof.

Examples of thermosetting resins that can be used in the polymer fibers include polyurethanes, epoxies, phenolics, polyesters, polyamides, silicones, and the like, or a combination thereof. Blends of thermosetting resins as well as blends of thermoplastic resins with thermosetting resins can be used.

Preferred polymer fibers that can be used in the thermally-insulating layer include an epoxy, a polyamide, a polyimide, a polyester such as PBT, a polyethylene, a polypropylene, a polystyrene, a polycarbonate, a polysulfone, a polyurethane, a silicone, a vinylester, or the like, or a combination thereof. In an aspect the polymer fiber comprises a heat resistant polymer, e.g., a polymer having a Tg of 180° C. or higher, such as a polyetherimide, a polysulfone, a polyphthalamide, a polyphenylene sulfide, a polyarylate, a polyether ether ketone, or the like, or a combination thereof. The polymer fibers can be in the form of woven or non-woven mats or tapes.

Exemplary fiberglass layers comprise A-glass, C-glass, D-glass, or a combination thereof. D-glass or E-glass is preferred. The fiberglass layer can dispose in a polymer matrix or coated with a polymer. An epoxy, a polyamide, a polyimide, a polyester such as poly(butylene terephthalate), a polyethylene, a polypropylene, a polystyrene, a polycarbonate, a polysulfone, a polyurethane, a silicone, a vinyl ester, or the like can be used. Preferred binders include epoxies, polyesters, and vinylesters. In an aspect, each first and second integrity layers comprise a plain weave 1080 E-glass.

The thermal management multilayer and subcombinations in the thermal management multilayer (e.g., the high temperature laminate) can be manufactured by methods known in the art depending on the materials used for the heat-spreading, thermally-insulating, and optional adhesive layers. Manufacture can be, for example, by stacking the layers individually and laminating. Alternatively, or in addition, the high temperature laminate can be obtained commercially and then assembled with one or more additional layers to form the thermal management multilayer. An example of a commercially available high temperature laminate is a plasma tape, e.g., an aluminum foil/glass fabric laminate further comprising a high temperature silicone adhesive disposed on the glass fabric. Such laminates are commercially available from DeWAL under the trade name DW series plasma tapes, such as the DW 407 plasma tape.

It is to be understood that the aspects shown in FIGS. 1-3 are exemplary only, and that various combinations and subcombinations can be used depending on the desired properties. For example, additional heat-spreading or adhesive, layers can be present.

Still other layers or components that can be present in the thermal management multilayer sheet include a phase-change material. Specifically, a layer comprising a phase change material can be present in the thermal management multilayer sheet. A phase-change material is a substance with a high heat of fusion and that is capable of absorbing and releasing high amounts of latent heat during a phase transition, such as melting and solidification, respectively. During the phase change, the temperature of the phase-change material remains nearly constant. The phase-change material inhibits or stops the flow of thermal energy through the material during the time the phase-change material is absorbing or releasing heat, typically during the material's change of phase. In some instances, a phase-change material can inhibit heat transfer during a period of time when the phase-change material is absorbing or releasing heat, typically as the phase-change material undergoes a transition between two states. This action is typically transient and will occur until a latent heat of the phase-change material is absorbed or released during a heating or cooling process. Heat can be stored or removed from a phase-change material, and the phase-change material typically can be effectively recharged by a source of heat or cold.

Suitable phase change materials are described, for example, in WO2020/227201. As described therein, the phase change materials can be encapsulated or unencapsulated, or a combination can be used. The phase change materials can be used in a composition further comprising a polymer as described above. The polymer can comprise one o or a combination as described above, for example polyvinyl chloride, polystyrene, polyether sulfone, ABS, SAN, PEN, PBT, PET, PVDF, perfluoromethylvinylether, polypropylene, polyethylene, copolymers of polyethylene or polypropylene, polytetrafluoroethylene (PTFE), FEP, vinylidene fluoride, HFP, EPR, EPDM, a natural rubber, a nitrile rubber, butyl rubber, a cyclic olefin copolymer, polydicyclopentadiene rubber, a thermoplastic polyurethane, SEPS, poly(styrene-butadiene-styrene) (SBS), SEBS, a polybutadiene, an isoprene, a polybutadiene-isoprene copolymer, or a combination thereof. The amount of the phase-change material can be 20 to 98 wt %, or 40 to 97 wt %, or 50 to 96 wt %, or 50 to 95 wt %, or 40 to 95 wt %, or 50 to 90 wt %, or 60 to 85 wt %, or 75 to 85 wt %, based on the total weight of the phase-change composition.

In an aspect, the thermal management multilayer sheet can comprise a layer comprising an intumescent composition. The layer can be disposed on the heat-spreading layer. Without being bound by any theory, it is believed that the intumescent material can reduce the spread of flames using two energy absorbing mechanisms, including forming a char and then swelling the char. For example, as the temperature reaches a value, for example, of 200 to 280° C., the acidic species (for example, of the polyphosphate acid) can react with the carbon source (for example, pentaerythritol) to form a char. As the temperature increases, for example, to 280 to 350° C., the blowing agent can then decompose to yield gaseous products that cause the char to swell. Intumescent materials are known, being described, for example, in WO2020/251825. The intumescent material can comprise an acid source, a blowing agent, and a carbon source. Each of these components can be present in separate layers or as an admixture, preferably an intimate admixture. For example, the intumescent material can comprise a polyphosphate acid source such as tris(2,3-dibromopropyl)phosphate, tris(2-chloroethyl)phosphate, tris(2,3-dichloropropyl)phosphate, tris(1-chloro-3-bromoisopropyl) phosphate, bis(1-chloro-3-bromoisopropyl)-1-chloro-3-bromoisopropyl phosphonate, polyaminotriazine phosphate, melamine phosphate, guanylurea phosphate, or a combination thereof, a carbon source such as dextrin, a phenol-formaldehyde resin, pentaerythritol, a clay, a polymer, or a combination thereof; and a blowing agent such dicyandiamide, an azodicarbonamide, a melamine, a guanidine, a glycine, a urea, a halogenated organic material, or a combination thereof.

An assembly for a battery can further include a pressure pad, also called a compression pad or a battery pad when in a battery, and referred herein as a “pressure pad” for convenience in all instances. The pad can be disposed between adjacent cells, or between cell arrays to address changes in compression, particularly during cell expansion. The pad can ensure a substantially constant pressure is maintained on the cells.

The pressure pad can be located at other positions within the battery. In an aspect, a pressure pad can have a thickness of 0.010 to 0.500 inches (254 to 12,700 μm) and comprises a compressible material that has a reliable consistent compression set resistance (c-set) and stress relaxation performance over a broad range of temperatures. Exemplary materials of this type include a polyurethane or silicone foams (such as a PORON® polyurethane foam or a BISCO® silicone foam available from Rogers Corporation). Other compressible materials that can be used as the pressure pad are those described herein. As used herein, “compressible” refers to an elastomeric property whereby the material compresses under pressure, and returns to its original state upon release of pressure.

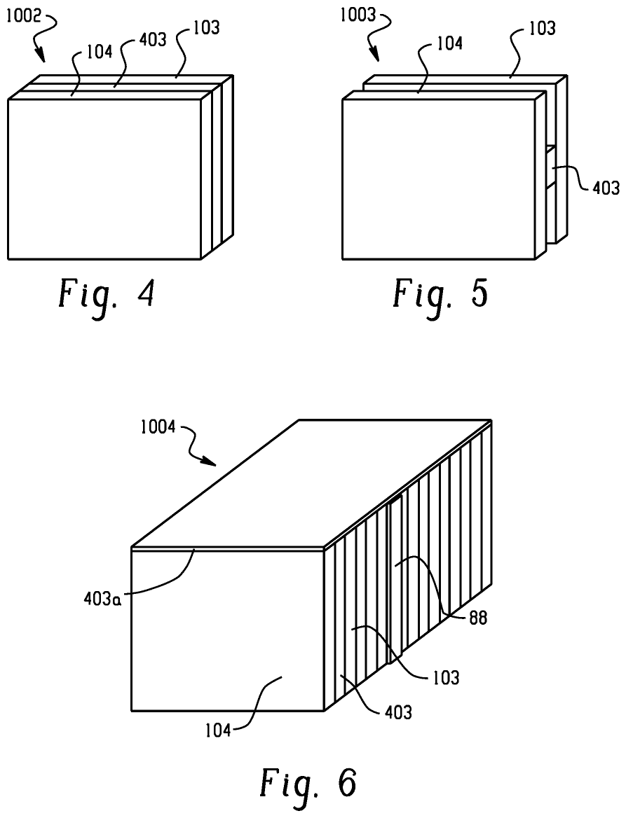

The thermal management multilayer sheet is disposed on an electrochemical cell, e.g., at least a portion of at least one electrochemical cell to provide a cell assembly for a battery. For example, FIG. 4 illustrates an aspect of the positioning of the thermal management multilayer sheet in an assembly 1002 for a battery and FIG. 5 illustrates an aspect of the positioning of the thermal management multilayer sheet in an assembly 1003 for a battery. The cells can be lithium-ion cells, in particular, pouch cells. FIG. 4 and FIG. 5 illustrate that the thermal management multilayer sheet 403 can be located between a first cell 103 and a second cell 104. FIG. 4 illustrates that the thermal management multilayer sheet 403 can be approximately the same size as the height and width of the cells 103, 104. FIG. 5 illustrates that the thermal management multilayer sheet 403 can be smaller than the respective cells 103, 104. It is possible for the thermal management multilayer sheet to extend past an edge of an electrochemical cell in order to cover at least a portion or all of a surface of the cell.

FIG. 6 illustrates that an assembly 1004 for a battery can comprise more than two cells (e.g., 103, 104) with thermal management multilayer sheet 403 located in between the respective cells 103, 104 and each of the other cells. In an aspect, two to ten fire-resistant thermal management multilayer sheets can be disposed on a cell or in a cell array during manufacture of the assembly 1004 for a battery. For example, two to ten thermal management multilayer sheets can be disposed on the interior, e.g., facing the electrodes, or exterior, facing outside of the battery. For example, two to ten fire-resistant thermal management multilayer sheets can be disposed on or adhered to a cell or pouch of a pouch cell, or both. Of course, one or more than ten of the thermal management multilayer sheets can be present depending on the number of cells and cell arrays. FIG. 6 further illustrates thermal management multilayer sheet 403a disposed on an exterior of assembly 1004 for a battery, to face outside of a battery.

In an aspect, at least a portion of the exposed outer edges of the thermal management multilayer sheet can comprise a material 88 that pulls heat away from the body of the thermal management multilayer sheet. Exemplary materials to apply to the exposed edges of the thermal management multilayer sheet include ceramics such as boron nitride or aluminum nitride, a metal such as aluminum, a high heat capacity wax, a phase change material, or the like, or a combination thereof.

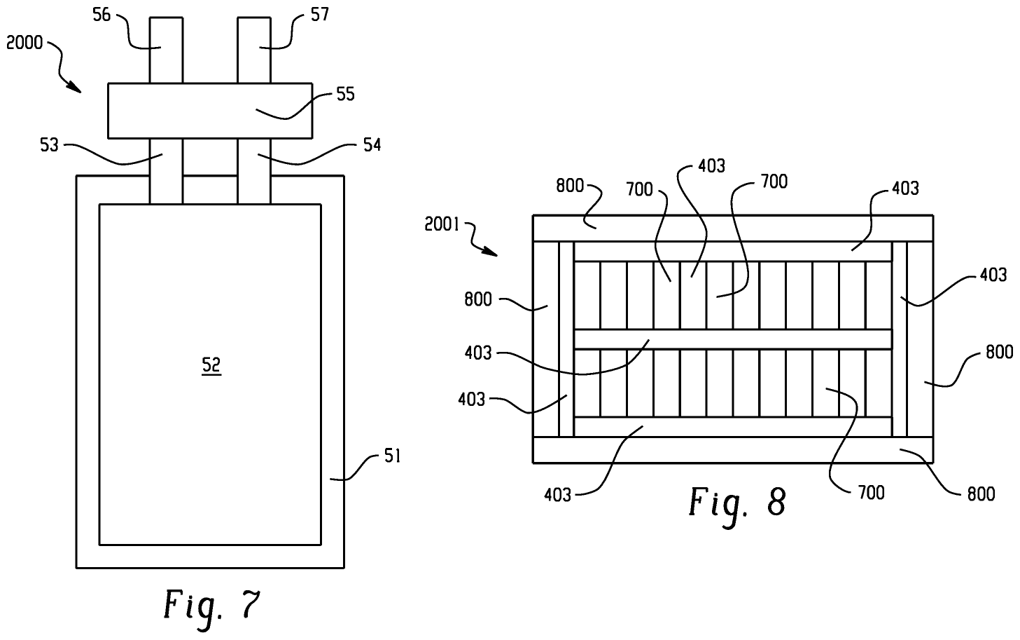

The cell assemblies are used in batteries. A battery includes a housing that at least partially encloses one or more electrochemical cells or cell arrays. As shown in FIG. 7, an exemplary battery 2000 can include a flexible housing, e.g., a pouch, 51 that surrounds and seals an electrode assembly 52. The enclosure for pouch cells or the battery of FIG. 7 is generally a laminate material including a metal foil layer. For example, a laminate pouch cell material can include a metal foil, such as an aluminum foil, between two polymer layers. The metal foil is intended to function as a barrier against all permeation, both into and out from the battery cell, including water diffusion. The laminate therefore completely encloses the electrochemical cell or cell array, sealing the cell or cell array. The thermal management multilayer sheet is additional to the housing, i.e., the pouch 51.

The electrode assembly 52 can include an anode, a separator, a cathode, and an electrolyte. The battery 2000 also includes a negative current collector 53 connected to an anode and a positive current collector 54 connected to a cathode. The negative current collector 53 and the positive current collector 54 can be electrically connected to a control electronic system 55 that includes the control electronics for the battery. The battery 2000 also includes a negative outside lead 56 and a positive outside lead 57 that enable connection of the battery 2000 to a circuit or device.

The thermal management multilayer sheet can be disposed on, or disposed directly on a cell or cell array in any configuration in a battery. The thermal management multilayer sheet can be placed between individual cells or cell arrays in the battery. The thermal management multilayer sheet can be placed on, e.g., at the top, in between, below, adjacent, or a combination thereof the sides of the cells or cell arrays in the battery, a portion thereof, or a selected set of cells or cell arrays in the battery. The thermal management multilayer sheet, for example, with no exposed adhesive, can be placed or adhered to a plurality of pouch cells, pressure management pads, cooling plates, or other interior battery components. The assembly pressure of the battery can hold stacked components into place.

For example, as shown in FIG. 8, a battery 2001 can contain a plurality cells in a plurality of cell arrays 700 inside a housing 800. The thermal management multilayer sheet 403 can be disposed between two cell arrays 700. Further as shown in FIG. 8, the thermal management multilayer sheet 403 can be disposed between a side of housing 800 and a side of a cell array 700, along a plurality of the cells of the cell array. Also as shown in FIG. 8, the thermal management multilayer sheet 403 can be disposed between an end of housing 800 and an end of one or more cell arrays 700.

Set forth below are non-limiting aspects of the present disclosure.

Aspect 1: A thermal management multilayer sheet, comprising a first heat-spreading layer, a first side of a first integrity layer disposed on a side of the first heat spreading layer, a first side of a first adhesive layer disposed on an opposite second side of the first integrity layer, a second integrity layer, and a second heat-spreading layer, wherein a first side of the second integrity layer is disposed on an opposite second side of the adhesive layer, and the second heat-spreading layer is disposed on an opposite second side of the second integrity layer, wherein the first adhesive layer is a single layer or multi-layer adhesive; or a first side of the second heat-spreading layer is disposed on an opposite second side of the first adhesive layer, a first side of the second integrity layer is disposed on an opposite second side of the second heat-spreading layer, and a second adhesive layer is disposed on an opposite second side of the second integrity layer.

Aspect 2: The thermal management multilayer sheet of aspect 1, wherein the first and second heat-spreading layers each independently have a thickness of 12.7 to 508 micrometers, preferably 25.4 to 127 micrometers, and each independently comprise copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof.

Aspect 3: The thermal management multilayer sheet of any of the foregoing aspects, wherein the first and second integrity layer each independently has a thickness of 25.4 to 508 μm, preferably 25.4 to 127 μm, preferably wherein the first and second integrity layer each independently comprises a woven or nonwoven mat comprising a high heat resistance polymer or glass.

Aspect 4: The thermal management multilayer sheet of any of the foregoing aspects, wherein the adhesive layer(s) comprise a polyester adhesive, a polyvinyl fluoride adhesive, an acrylic or methacrylic adhesive, a silicone adhesive, or a combination thereof.

Aspect 5: The thermal management multilayer sheet of any of the foregoing aspects, wherein the adhesive layer(s) further comprise a filler, such as aerogel fillers, glass microballoons, gas-filled hollow polymer microspheres, boron nitride, aluminum nitride, mica, talc, carbon nanotubes, graphite, or a combination thereof.

Aspect 6: The multilayer fire-resistant composite of any of the foregoing aspects, comprising two to ten foil layers, preferably three to ten foil layers, and two to ten integrity layers, preferably three to ten integrity layers.

Aspect 7: The thermal management multilayer sheet of any of the foregoing aspects, wherein at least a portion of the exposed outer edges of the thermal management multilayer sheet comprise a composition that pulls heat away from the body of the composite, such as a ceramic, a high heat capacity wax, a phase change material, or a combination thereof.

Aspect 8: An assembly for a battery comprising at least two electrochemical cells, and the thermal management multilayer sheet of any of the foregoing aspects.

Aspect 9: The assembly for a battery of aspect 8, wherein the thermal management multilayer sheet is between the at least two electrochemical cells.

Aspect 10: An assembly for a battery comprising at least two electrochemical cells; and a thermal management multilayer sheet, wherein the thermal management multilayer sheet comprises a first heat-spreading layer, a first side of a first integrity layer disposed on a side of the first heat spreading layer, and an adhesive layer disposed on an opposite second side of the first integrity layer.

Aspect 11: The assembly for a battery of aspect 10, wherein the first heat-spreading layer has a thickness of 12.7 to 508 micrometers, preferably 25.4 to 127 micrometers, and comprises copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof.

Aspect 12: The assembly for a battery of aspect 10 or 11, wherein the integrity layer has a thickness of 25.4 to 508 μm, preferably 25.4 to 127 μm, preferably wherein the integrity layer comprises a woven or nonwoven mat comprising a high heat resistance polymer or glass.

Aspect 13: The assembly for a battery of any one of aspects 10-12, wherein the adhesive layer comprises a polyester adhesive, a polyvinyl fluoride adhesive, an acrylic or methacrylic adhesive, a silicone adhesive, or a combination thereof.

Aspect 14: The assembly for a battery of any one of aspects 10-13, wherein at least a portion of the exposed outer edges of the thermal management multilayer sheet comprise a composition that pulls heat away from the body of the composite, such as a ceramic, a high heat capacity wax, a phase change material, or a combination thereof.

Aspect 15: The assembly for a battery of any one of aspects 10-14, wherein the thermal management multilayer sheet is between the at least two electrochemical cells.

Aspect 16: The assembly for a battery of any one of aspects 10-15, comprising two to 10 of the thermal management multilayer sheets.

Aspect 17: The assembly for a battery of any one of aspects 10-16, wherein the electrochemical cells are lithium-ion cells.

Aspect 18: The assembly for a battery of any one of aspects 10-17, wherein the electrochemical cells are prismatic cells, pouch cells, or cylindrical cells.

Aspect 19: The assembly for a battery of any one of aspects 10-18, wherein the electrochemical cell is a pouch cell, and the thermal management multilayer sheet is disposed on and/or adhered to the interior, exterior or both of the flexible housing of the pouch cell.

Aspect 20: A battery comprising the assembly for a battery of any one of aspects 8-19.

Aspect 21: The battery of aspect 20, further comprising a housing at least partially enclosing the assembly for a battery.

The compositions, methods, and articles described herein can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, “another aspect”, and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film (including the thermally-insulating multilayer film), region, or substrate is referred to as being “on” another element, it is adjacent the other element, and can be directly on the other element or intervening elements can also be present. In contrast, when an element is referred to as being “directly on” another element, there are no intervening elements present. Further when an element such as a layer, film (including the thermally-insulating multilayer film), region, or substrate is referred to as being “on” or “directly on” another element, all or a portion of the element can be adjacent all or a portion of the other element.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. The terms “first,” “second,” and the like, “primary,” “secondary,” and the like, as used herein do not denote any order, quantity, or importance, but rather are used to distinguish one element from another. The term “combination thereof” or “at least one of” means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

In the drawings, the widths and thicknesses of layers and regions are exaggerated for clarity of the specification and convenience of explanation. Like reference numerals in the drawings denote like elements.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

While particular aspects have been described, alternatives, modifications, variations, improvements, and substantial equivalents that are or can be presently unforeseen can arise to applicants or others skilled in the art. Accordingly, the appended claims as filed and as they can be amended are intended to embrace all such alternatives, modifications variations, improvements, and substantial equivalents.

What is claimed is:

1. A thermal management multilayer sheet, comprising
a first heat-spreading layer,
a first side of a first integrity layer disposed on a side of the first heat spreading layer,
a first side of a first adhesive layer disposed on an opposite second side of the first integrity layer,
a second integrity layer, and
a second heat-spreading layer,
wherein
a first side of the second integrity layer is disposed on an opposite second side of the adhesive layer, and
the second heat-spreading layer is disposed on an opposite second side of the second integrity layer,
wherein the first adhesive layer is a single layer or multi-layer adhesive; or
a first side of the second heat-spreading layer is disposed on an opposite second side of the first adhesive layer,
a first side of the second integrity layer is disposed on an opposite second side of the second heat-spreading layer, and
a second adhesive layer is disposed on an opposite second side of the second integrity layer.

2. The thermal management multilayer sheet of claim 1, wherein the first and second heat-spreading layers each independently have a thickness of 12.7 to 508 micrometers, and each independently comprise copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof.

3. The thermal management multilayer sheet of claim 1, wherein the first and second integrity layer each independently has a thickness of 25.4 to 508 μm.

4. The thermal management multilayer sheet of claim 1, wherein the adhesive layer(s) comprise a polyester adhesive, a polyvinyl fluoride adhesive, an acrylic or methacrylic adhesive, a silicone adhesive, or a combination thereof.

5. The thermal management multilayer sheet of claim 1, wherein the adhesive layer(s) further comprise a filler, such as aerogel fillers, glass microballoons, gas-filled hollow polymer microspheres, boron nitride, aluminum nitride, mica, talc, carbon nanotubes, graphite, or a combination thereof.

6. The thermal management multilayer sheet of claim 1, wherein at least a portion of the exposed outer edges of the thermal management multilayer sheet comprise a composition that pulls heat away from the body of the composite, such as a ceramic, a high heat capacity wax, a phase change material, or a combination thereof.

7. An assembly for a battery comprising
at least two electrochemical cells, and
the thermal management multilayer sheet of claim 1.

8. The assembly for a battery of claim 7, wherein the thermal management multilayer sheet is between the at least two electrochemical cells.

9. An assembly for a battery comprising
at least two electrochemical cells; and
a thermal management multilayer sheet,
wherein the thermal management multilayer sheet comprises
a first heat-spreading layer,
a first side of a first integrity layer disposed on a side of the first heat spreading layer, and
an adhesive layer disposed on an opposite second side of the first integrity layer.

10. The assembly for a battery of claim 9, wherein the first heat-spreading layer has a thickness of 12.7 to 508 micrometers, and comprises copper, aluminum, silver, a copper alloy, an aluminum alloy, a silver alloy, boron nitride, aluminum nitride, silicon carbide, beryllium oxide, carbon fibers, carbon nanotubes, graphene, graphite, or a combination thereof.

11. The assembly for a battery of claim 9, wherein the integrity layer has a thickness of 25.4 to 508 μm.

12. The assembly for a battery of claim 9, wherein the adhesive layer comprises a polyester adhesive, a polyvinyl fluoride adhesive, an acrylic or methacrylic adhesive, a silicone adhesive, or a combination thereof.

13. The assembly for a battery of claim 9, wherein at least a portion of the exposed outer edges of the thermal management multilayer sheet comprise a composition that pulls heat away from the body of the composite, such as a ceramic, a high heat capacity wax, a phase change material, or a combination thereof.

14. The assembly for a battery of claim 9, wherein the thermal management multilayer sheet is between the at least two electrochemical cells.

15. The assembly for a battery of claim 9, comprising two to 10 of the thermal management multilayer sheets.

16. The assembly for a battery of claim 9, wherein the electrochemical cells are lithium-ion cells.

17. The assembly for a battery of claim 9, wherein the electrochemical cells are prismatic cells, pouch cells, or cylindrical cells.

18. The assembly for a battery of claim 9, wherein the electrochemical cell is a pouch cell, and the thermal management multilayer sheet is disposed on and/or adhered to the interior, exterior or both of the flexible housing of the pouch cell.

19. A battery comprising
the assembly for a battery of claim 9.

20. The battery of claim 19, further comprising
a housing at least partially enclosing the assembly for a battery.
